(19) United States
(12) Patent Application Publication
(10) Pub. No.: US 2026/0085553 A1
(43) Pub. Date: Mar. 26, 2026

(54) AN INTERIOR DOOR HANDLE MECHANISM WITH A SLIDING GRIP

(71) Applicant: Minebea Accesssolutions South America Ltda., GUARULHOS (BR)

(72) Inventor: Vagner SOARES, Guarulhos (BR)

(73) Assignee: Minebea Accesssolutions South America Ltda., GUARULHOS, SP (BR)

(21) Appl. No.: 19/334,013

(22) Filed: Sep. 19, 2025

(30) Foreign Application Priority Data
Sep. 20, 2024 (EP) 24201605.3

(51) Int. Cl. E05B 85/12; E05B 79/20

(52) U.S. Cl. CPC E05B 85/12; E05B 79/20

(57) ABSTRACT

An interior handle mechanism for a vehicle includes: a support extending according to a main axis, the support being configured to be mounted to a receiving location made within an interior lining of the vehicle; a sliding grip configured to cooperate with the support, the sliding grip being movable according to the main axis between a rest position and a pulled position; a pulling device arranged to link the sliding grip and an opening cable of a door or compartment of the vehicle, the pulling device being configured to pull on the opening cable when the sliding grip is moved from the rest position to the pulled position.

### CROSS-REFERENCE TO RELATED APPLICATIONS

This application claims priority to and the benefit of EP 24201605.3 filed on September 20, 2024, the disclosure of which is incorporated herein by reference.

### FIELD

The present disclosure relates to an interior door handle mechanism with a sliding grip.

### BACKGROUND

The statements in this section merely provide background information related to the present disclosure and may not constitute prior art.

It is known to have handles that are located in the interior of a vehicle for opening doors or compartments such as the engine compartment, the filler door, the trunk or a passenger door.

A possibility for opening such a door is to have a dedicated mechanism that pulls an internal steel cable of the vehicle that is linked to the door or compartment that has to be opened.

Usually, when the steel cable is pulled, the corresponding door or compartment opens is set in an openable position, the user having then to displace said door or compartment.

When the tension on the cable is released, the door or compartment can return to its initial closed position. This is especially true for a passenger door handle where a grip of the handle is moved by the user for opening said passenger door, the corresponding cable returning to its initial position when the user releases the grip after exiting the vehicle.

A possibility is to have a rotating grip that moves around an axis made in the rest part of the handle. This rotation moves internal parts of the dedicated mechanism for pulling the cable.

This kind of handle and dedicated mechanism often comprises several pieces that cooperate together to pull the steel cable in response to the displacement of the grip of the handle.

As a result, such a dedicated mechanism can comprise a lot of parts which can be arranged in a complex way so that the steel cable is correctly pulled relatively to the movement of the grip of the handle.

There is therefore a need for simplifying such a dedicated mechanism for pulling the steel cable.

### SUMMARY

This section provides a general summary of the disclosure and is not a comprehensive disclosure of its full scope or all of its features.

The present invention aims to solve all or some of the disadvantages mentioned above.

For this purpose, the present invention relates to an interior handle mechanism for a vehicle including: a support extending according to a main axis, the support being configured to be mounted to a receiving location made within an interior lining of the vehicle; a sliding grip configured to cooperate with the support, the sliding grip being movable according to the main axis between a rest position and a pulled position; and a pulling device arranged to link the sliding grip and an opening cable of a door or compartment of the vehicle. The pulling device is configured to pull on the opening cable when the sliding grip is moved from the rest position to the pulled position.

In other words, the sliding grip is movable linearly between the rest position to the pulled position. This provision enables to have a simple pulling device with a limited number of parts and that is easy to integrate to the interior of the vehicle.

Indeed, there is less space needed for a sliding grip than for a rotating grip to be accessible to the user. The interior handle mechanism can then be applied to doors or compartments of the vehicle whose opening or openable state is triggered by an opening cable of the vehicle.

According to an aspect of the invention, the opening cable is a steel cable or a cable in a material with properties equivalent to the properties of steel.

According to an aspect of the invention, the pulling device comprises a lever rotatably mounted on the support so as to rotate around a rotation axis that is transversal to the main axis, the lever being arranged to cooperate with the opening cable and with the sliding grip.

The lever is a unique intermediate element between the sliding grip and the opening cable. Preferably, the support is provided with an axle that extends according to the rotation axis and that is configured to cooperate with a rotation opening of the lever.

According to an aspect of the invention, the lever comprises a first extremity including a fixing area for the opening cable and a second extremity arranged to cooperate with the sliding grip, the rotation axis being between the first extremity and the second extremity according to an extension axis of the lever.

When the lever rotates, the sliding grip and the opening cable are moving in opposite directions with respect to the main axis. This is due to the form of the lever which presents a generally oblong form according to the extension axis. Thus, the first extremity, the rotation axis and the second extremity are aligned according to the extension axis.

According to an aspect of the invention, the fixing area includes a through hole made in the lever that is extending in parallel to the rotation axis.

This provision simplifies the fixation of the opening cable to the lever: the opening cable has to be winded and tied on the first extremity using the through hole. Preferably, the fixing area also includes a notch made on an external outline of the lever and extending in parallel to the through hole so as to help fixing the opening cable.

According to an aspect of the invention, the second extremity presents an oblong through opening extending in parallel to the rotation axis and wherein the sliding grip includes a pin that is configured to extend within the oblong through opening.

Said opening extends in parallel to the rotation axis whereas the oblong form extends according to the extension axis of the lever.

This form implies that the opening cable is not pulled in a circular way but in a flattened trajectory. Overall, the main axis and the displacement of a tip of the opening cable happens in the same plane or in parallel planes which confers a compact design to the interior handle mechanism.

The sliding grip presents an extension including the pin so that the pulling device can be hidden in the interior lining of the vehicle.

According to an aspect of the invention, the interior handle mechanism also comprises a return element configured to cooperate with the support and with the sliding grip so as to move the sliding grip in the rest position when the sliding grip is not moved manually.

This provision facilitates the use of the interior handle mechanism as by default the sliding grip remains or moves to the rest position.

According to an aspect of the invention, the return element is a spring, each extremity of the spring being configured to cooperate with a corresponding shoulder of the support and the sliding grip extending transverse to the main axis.

According to an aspect of the invention, the support presents a basis wall and a cooperation wall extending transversally to the basis wall, the cooperation wall being configured to cooperate with a groove made in the sliding grip.

This simple geometry makes it easy to manufacture the interior handle mechanism. According to an aspect of the invention, the cooperation wall extends in parallel to the axle.

Preferably, the interior handle mechanism comprises a supplementary wall extending from and parallel to the basis wall, the supplementary wall including the axle. This provision enables not to disturb the cooperation between the support and the sliding grip so that the sliding grip can move easily between the rest position and the pulled position.

The shoulder of the support that is configured to cooperate with the return element is made on the basis wall or on the supplementary wall or at the limit between the two elements.

According to an aspect of the invention, the support includes an adapter configured to fix a fitting of a sheath of the vehicle receiving the opening cable, said adapter extending transversally to the main axis.

The adapter also extends in parallel to the rotation axis. As the sheath is fixed to the adapter, in absence of a solicitation, the opening cable is maintained by the lever and the sheath by the adapter so that the lever always has the same orientation. This defines the rest position.

According to an aspect of the invention, the adapter presents a slot for inserting the fitting of the sheath and shoulders to prevent a move from the fitting transversally to the slot. The slot enables to install manually the fitting and withdraw it if necessary. Preferably, the adapter is reported on the supplementary wall.

According to an aspect of the invention, the sliding grip presents a recess adapted for a manual displacement of the sliding grip between the rest position and the pulled position.

This form of the sliding grip enables to easily integrate the interior handle mechanism within the vehicle as there is no protruding part that is used for manual actuation of the sliding grip.

The present invention also concerns an interior part of the vehicle comprising an interior handle mechanism as described above, wherein the interior part has one receiving location wherein the interior handle mechanism is received so that a part of the sliding grip only is accessible from the receiving location in the rest position.

The overall design of the interior part hides almost every part of the inter handle mechanism for its protection except a part of the sliding grip which is visible and accessible from the receiving location by a user.

In other words, said part of the sliding grip closes the receiving location opening in rest position. In pulled position, some internal parts can become visible from the outside as the support.

According to an aspect of the invention, said interior part is a handle assembly including electronics configured to lock and unlock a closing mechanism of a door, the interior handle mechanism being also configured to lock and unlock said closing mechanism.

The interior handle mechanism is a redundant mechanism that be used when the electronics is not working, for example during a failure of the vehicle. Due to its geometry, the interior handle mechanism can be installed in a discreet place so that the handle assembly appears as the main command to open the door.

The present invention concerns a door of the vehicle and also concerns a vehicle comprising said door.

The different aspects defined above that are not incompatible can be combined.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a front view of an interior handle mechanism for a vehicle;

FIG. 2 is an exploded view of the interior handle mechanism;

FIG. 3 is a perspective view of a door with said interior handle mechanism; and

FIG. 4 is another perspective view of the door with said interior handle mechanism.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description of the figures defined above, the same elements or the elements that are fulfilling identical functions may retain the same references so as to simplify the understanding of the invention.

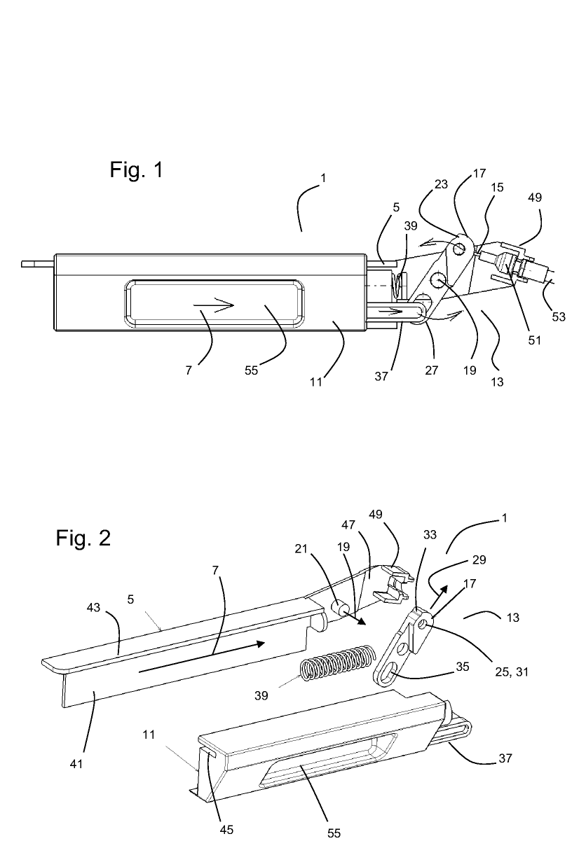

As illustrated in FIGS. 1 to 4, an interior handle mechanism 1 for a vehicle 3 comprises a support 5 extending according to a main axis 7. The support 5 is configured to be mounted to a receiving location 9 made within an interior lining of the vehicle 3.

The interior handle mechanism 1 comprises a sliding grip 11 configured to cooperate with the support 5, the sliding grip 11 being movable according to the main axis 7 between a rest position illustrated in FIG. 1 and a pulled position symbolized by the arrows in FIG. 1.

The interior handle mechanism 1 comprises a pulling device 13 arranged to link the sliding grip 11 and an opening cable 15 of a door or compartment of the vehicle 3, the pulling device 13 being configured to pull on the opening cable 15 when the sliding grip 11 is moved from the rest position to the pulled position.

In other words, the sliding grip 11 is movable linearly between the rest position to the pulled position.

This provision enables to have a simple pulling device 13 with a limited number of parts and that is easy to integrate to the interior of the vehicle 3.

Indeed, there is less space needed for a sliding grip 11 than for a rotating grip to be accessible to the user. The interior handle mechanism 1 can then be applied to doors or compartments of the vehicle 3 whose opening or openable state is triggered by an opening cable 15 of the vehicle 3.

The opening cable 15 is a steel cable or a cable in a material with properties equivalent to the properties of steel.

The pulling device 13 comprises a lever 17 rotatably mounted on the support 5 so as to rotate around a rotation axis 19 that is transversal to the main axis 7, the lever 17 being arranged to cooperate with the opening cable 15 and with the sliding grip 11.

The lever 17 is a unique intermediate element between the sliding grip 11 and the opening cable 15. The support 5 is provided with an axle 21 that extends according to the rotation axis 19 and that is configured to cooperate with a rotation opening of the lever 17.

The lever 17 comprises a first extremity 23 including a fixing area 25 for the opening cable 15 and a second extremity 27 arranged to cooperate with the sliding grip 11, the rotation axis 19 being between the first extremity 23 and the second extremity 27 according to an extension axis 29 of the lever 17.

When the lever 17 rotates, the sliding grip 11 and the opening cable 15 are moving in opposite directions with respect to the main axis 7. This is due to the form of the lever 17 which presents a generally oblong form according to the extension axis 29. Thus, the first extremity 23, the rotation axis 19 and the second extremity 27 are aligned according to the extension axis 29.

The fixing area 25 includes a through hole 31 made in the lever 17 that is extending in parallel to the rotation axis 19.

This provision simplifies the fixation of the opening cable 15 to the lever 17: the opening cable 15 has to be winded and tied on the first extremity 23 using the through hole 31.

The fixing area 25 also includes a notch 33 made on an external outline of the lever 17 and extending in parallel to the through hole 31 so as to help fixing the opening cable 15.

The second extremity 27 presents an oblong through opening 35 extending in parallel to the rotation axis 19 and wherein the sliding grip 11 includes a pin that is configured to extend within the oblong through opening 35.

Said opening extends in parallel to the rotation axis 19 whereas the oblong form extends according to the extension axis 29 of the lever 17.

This form implies that the opening cable 15 is not pulled in a circular way but in a flattened trajectory. Overall, the main axis 7 and the displacement of a tip of the opening cable 15 happens in the same plane or in parallel planes which confers a compact design to the interior handle mechanism 1.

The sliding grip 11 presents an extension 37 including the pin so that the pulling device 13 can be hidden in the interior lining of the vehicle 3.

The interior handle mechanism 1 also comprises a return element 39 configured to cooperate with the support 5 and with the sliding grip 11 so as to move the sliding grip 11 in rest position when the sliding grip 11 is not moved manually.

This provision facilitates the use of the interior handle mechanism 1 as by default the sliding grip 11 remains or moves to the rest position.

The return element 39 is a spring, each extremity of the spring being configured to cooperate with a corresponding shoulder of the support 5 and the sliding grip 11 extending transverse to the main axis 7.

The support 5 presents a basis wall 41 and a cooperation wall 43 extending transversally to the basis wall 41, the cooperation wall 43 being configured to cooperate with a groove 45 made in the sliding grip 11.

This simple geometry makes it easy to manufacture the interior handle mechanism 1. The cooperation wall 43 extends in parallel to the axle 21.

The interior handle mechanism 1 comprises a supplementary wall 47 extending from and parallel to the basis wall 41, the supplementary wall 47 including the axle 21. This provision enables not to disturb the cooperation between the support 5 and the sliding grip 11 so that the sliding grip 11 can move easily between the rest position and the pulled position.

The shoulder of the support 5 that is configured to cooperate with the return element 39 is made on the basis wall 41 or on the supplementary wall 47 or at the limit between the two elements.

The support 5 includes an adapter 49 configured to fix a fitting 51 of a sheath 53 of the vehicle 3 receiving the opening cable 15, said adapter 49 extending transversally to the main axis 7.

The adapter 49 also extends in parallel to the rotation axis 19. As the sheath 53 is fixed to the adapter 49, in absence of a solicitation, the opening cable 15 is maintained by the lever 17 and the sheath 53 by the adapter 49 so that the lever 17 always has the same orientation. This defines the rest position.

The adapter 49 presents a slot for inserting the fitting 51 of the sheath 53 and shoulders to prevent a move from the fitting 51 transversally to the slot. The slot enables to install manually the fitting 51 and withdraw it if necessary. Here, the adapter 49 is reported on the supplementary wall 47.

The sliding grip 11 presents a recess 55 adapted for a manual displacement of the sliding grip 11 between the rest position and the pulled position.

This form of the sliding grip 11 enables to easily integrate the interior handle mechanism 1 within the vehicle 3 as there is no protruding part that is used for manual actuation of the sliding grip 11.

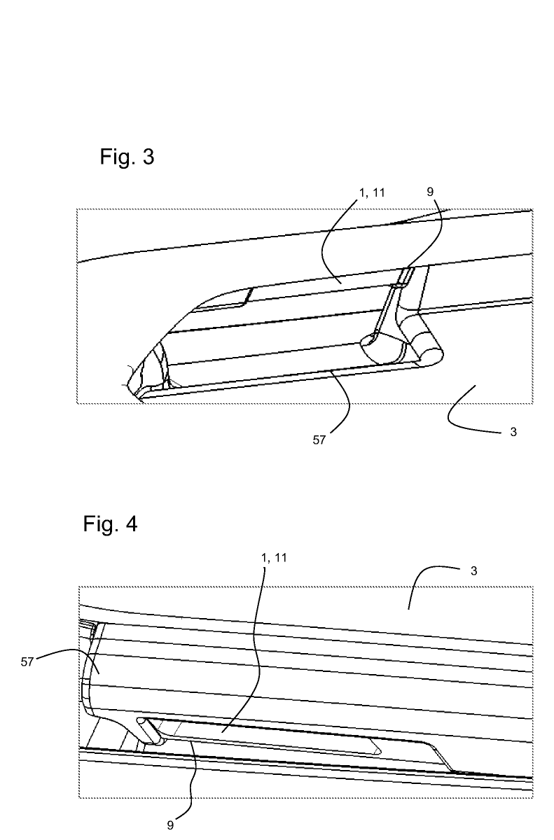

As illustrated in FIGS. 3 and 4, an interior part 57 of the vehicle 3 comprises an interior handle mechanism 1 as described above.

The interior part 57 has one receiving location 9 wherein the interior handle mechanism 1 is received so that a part of the sliding grip 11 only is accessible from the receiving location 9 in rest position.

The overall design of the interior part 57 hides almost every part of the interior handle mechanism 1 for its protection except a part of the sliding grip 11 which is visible and accessible from the receiving location 9 by a user.

In other words, said part of the sliding grip 11 closes the receiving location 9 opening in rest position. In pulled position, some internal parts can become visible from the outside as the support 5.

Said interior part 57 is a handle assembly including electronics configured to lock and unlock a closing mechanism of a door, the interior handle mechanism 1 being also configured to lock and unlock said closing mechanism.

The interior handle mechanism 1 is a redundant mechanism that be used when the electronics is not working, for example during a failure of the vehicle 3. Due to its geometry, the interior handle mechanism 1 can be installed in a discreet place so that the handle assembly appears as the main command to open the door.

The present invention concerns a door of the vehicle 3 and also concerns a vehicle 3 comprising said door.

As goes without saying, the invention is not limited to the sole embodiment described above by way of example, it encompasses all the variants.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An interior handle mechanism for a vehicle, comprising:
a support extending according to a main axis, the support being configured to be mounted to a receiving location made within an interior lining of the vehicle;
a sliding grip configured to cooperate with the support, the sliding grip being movable according to the main axis between a rest position and a pulled position; and
a pulling device arranged to link the sliding grip and an opening cable of a door or compartment of the vehicle, the pulling device being configured to pull on the opening cable when the sliding grip is moved from the rest position to the pulled position.

2. The interior handle mechanism according to claim 1, wherein the pulling device comprises a lever rotatably mounted on the support so as to rotate around a rotation axis that is transversal to the main axis, the lever being arranged to cooperate with the opening cable and with the sliding grip.

3. The interior handle mechanism according to claim 2, wherein the lever comprises a first extremity including a fixing area for the opening cable and a second extremity arranged to cooperate with the sliding grip, the rotation axis being between the first extremity and the second extremity according to an extension axis of the lever.

4. The interior handle mechanism according to claim 3, wherein the fixing area includes a through hole made in the lever that is extending in parallel to the rotation axis.

5. The interior handle mechanism according to claim 3, wherein the second extremity presents an oblong through opening extending in parallel to the rotation axis and wherein the sliding grip includes a pin that is configured to extend within the oblong through opening.

6. The interior handle mechanism according to claim 1, further comprising a return element configured to cooperate with the support and with the sliding grip so as to move the sliding grip in the rest position when the sliding grip is not moved manually.

7. The interior handle mechanism according to claim 1, wherein the support presents a basis wall and a cooperation wall extending transversally to the basis wall, the cooperation wall being configured to cooperate with a groove made in the sliding grip.

8. The interior handle mechanism according to claim 1, wherein the support includes an adapter configured to fix a fitting of a sheath of the vehicle receiving the opening cable, said adapter extending transversally to the main axis.

9. The interior handle mechanism according to claim 1, wherein the sliding grip presents a recess adapted for a manual displacement of the sliding grip between the rest position and the pulled position.

10. An interior part of the vehicle comprising the interior handle mechanism according to claim 1,
wherein the interior part has one receiving location wherein the interior handle mechanism is received so that a part of the sliding grip only is accessible from the receiving location in the rest position.

11. The interior part of the vehicle according to claim 10, wherein said interior part is a handle assembly including electronics configured to lock and unlock a closing mechanism of a door, the interior handle mechanism being also configured to lock and unlock said closing mechanism.
